(19) United States
(12) Patent Application Publication
(10) Pub. No.: US 2026/0350846 A1
(43) Pub. Date: Nov. 5, 2026

(54) METHOD FOR ENCODING AND DECODING A 3D POINT CLOUD, ENCODER, DECODER

(71) Applicant: Beijing Xiaomi Mobile Software Co., Ltd., Beijing (CN)

(72) Inventor: Shuo GAO, Beijing (CN)

(21) Appl. No.: 19/102,694

(22) PCT Filed: Aug. 11, 2022
(86) PCT No.: PCT/CN2022/111931

§ 371 Date: Feb. 10, 2025

(51) Int. Cl. G06T 9/00; G06T 9/40

(52) U.S. Cl. CPC G06T 9/001; G06T 9/40

(57) ABSTRACT

A method for decoding a 3D point cloud from a bitstream is implemented in a decoder, a geometry of the point cloud being defined in an octree-based structure having a plurality of nodes having parent-child relationships and representing a three-dimensional location of an object, the point cloud being located within a volumetric space of a three-dimensional coordinate system recursively split into sub-volumes and containing points of the point cloud, wherein a volume is partitioned into a set of sub-volumes, each associated with a node of the octree-based structure. The method includes: obtaining nodes encompassing at least part of the point cloud at a depth d in a lexicographic order along each of axes X, Y, Z of the coordinate system; and entropy decoding occupancy information of the child nodes of each node from the bitstream based on the lexicographic order.

### CROSS-REFERENCE TO RELATED APPLICATIONS

The present application is a U.S. National Stage of International Application No. PCT/CN2022/111931, filed on Aug. 11, 2022, the disclosure of which is incorporated herein by reference in its entirety.

### TECHNICAL FIELD

The present disclosure relates to a method for encoding a 3D point cloud into a bitstream. Additionally, it is an object of the present disclosure to provide a method for decoding a 3D point cloud from a bitstream. Further, it is an object of the present disclosure to provide an encoder and decoder, a bitstream encoded according to the present disclosure and a software. In particular, it is an object of the present disclosure to provide a method with increased efficiency of coding and with reduced latency of processing.

### BACKGROUND

As a format for the representation of 3D data, point clouds have recently gained traction as they are versatile in their capability in representing all types of 3D objects or scenes. Therefore, many use cases can be addressed by point clouds, among which are
movie post-production,
real-time 3D immersive telepresence or VR/AR applications,
free viewpoint video (for instance for sports viewing),
Geographical Information Systems (aka cartography),
culture heritage (storage of scans of rare objects into a digital form),
Autonomous driving, including 3D mapping of the environment and real-time Lidar data acquisition

A point cloud is a set of points located in a 3D space, optionally with additional values attached to each of the points. These additional values are usually called point attributes. Consequently, a point cloud is combination of a geometry (the 3D position of each point) and attributes.

Attributes may be, for example, three-component colours, material properties like reflectance and/or two-component normal vectors to a surface associated with the point.

Point clouds may be captured by various types of devices like an array of cameras, depth sensors, Lidars, scanners, or may be computer-generated (in movie post-production for example). Depending on the use cases, points clouds may have from thousands to up to billions of points for cartography applications.

Raw representations of point clouds require a very high number of bits per point, with at least a dozen of bits per spatial component X, Y or Z, and optionally more bits for the attribute(s), for instance three times 10 bits for the colours. Practical deployment of point-cloud-based applications requires compression technologies that enable the storage and distribution of point clouds with reasonable storage and transmission infrastructures.

### SUMMARY

In a first aspect of the present disclosure, a method for decoding a 3D point cloud into a bitstream, implemented in a decoder is provided. A geometry of the point cloud being defined in a octree structure having a plurality of nodes having parent-child relationships and representing a three-dimensional location of an object, the point cloud being located within a volumetric space of a three-dimensional coordinate system recursively split into sub-volumes and containing points of the point cloud, wherein a volume is partitioned into a set of sub-volumes, each associated with a node of the octree-based structure and wherein an occupancy information associated with each respective child sub-volume indicates whether that respective child sub-volume contains at least one of the points, the method includes:
obtaining nodes encompassing at least part of the point cloud at depth d in a lexicographic order along each of the axes X, Y, Z of the coordinate system; and
entropy decoding the occupancy information of the child nodes of each node from a bitstream based on the lexicographic order.

In another aspect, a method for encoding a 3D point cloud into a bitstream, implemented in an encoder is provided. A geometry of the point cloud being defined in an octree structure having a plurality of nodes having parent-child relationships and representing a three-dimensional location of an object, the point cloud being located within a volumetric space of a three-dimensional coordinate system recursively split into sub-volumes and containing points of the point cloud, wherein a volume is partitioned into a set of sub-volumes, each associated with a node of the octree-based structure and wherein an occupancy information associated with each respective child sub-volume indicates whether that respective child sub-volume contains at least one of the points, the method includes:
obtaining nodes encompassing at least part of the point cloud at depth d in a lexicographic order along each of the axes X, Y, Z of the coordinate system;
entropy encoding the occupancy information of the child nodes of each node into a bitstream based on the lexicographic order.

A point cloud is a set of points in a three-dimensional coordinate system. The points are often intended to represent the external surface of one or more objects. Each point has a location (position) in the three-dimensional coordinate system. The position may be represented by three coordinates (X, Y, Z), which can be Cartesian or any other coordinate system. Thus, according to the present disclosure, for a given depth d in the octree, the nodes are obtained in a lexicographic order and the child nodes' occupancy is coded following the lexicographic order for a full resolution. Preferably, the nodes are stored in a linked data structure(for instance a linked list). Therein, the linked data structure has elements connected to each other so that elements are arranged in a sequential manner. Preferably, a list L_{d} can be used to store the nodes and the nodes can be obtained iteratively from the list. With the lexicographic ordering (whatever is the axis ordering used in lexicographic order), the occupancy of any child volume with a lower z, a lower y or a lower x position may be used for contextualization. Therefore, the prediction is more stable with different child volume position in lexicographic order than the prior art (e.g., Morton order). Thus, the coding efficiency is improved, and the processing latency is reduced.

In some embodiments, the method further comprises storing occupied child nodes at depth d+1 in a lexicographic order. Thus, if the nodes at depth d are not leaf nodes, it is possible to continue traversing the octree in a lexicographic order. The child nodes in the next depth d+1 is already stored in a preferred order, thereby further facilitating the next iteration.

In some embodiments, the lexicographic order of nodes at depth d and/or the lexicographic order of nodes at depth d+1 is a raster scan order.

In some embodiments, the entropy encoding or decoding of the occupancy information of the child nodes of each node at depth d into or from a bitstream is based on the lexicographic order of child nodes at depth d+1.Thus, the occupancy of any child node with a lower z, a lower y or a lower x position than the coded child node can be used for contextualization. Then, a predetermined pattern of neighbouring child nodes can thus be defined and can be used to select coding context for any coded occupancy bit.

In some embodiments, the entropy encoding or decoding of the occupancy information of the child nodes of each node into or from a bitstream is further based on the same neighbouring child node occupancy pattern indicating contexts for each child node. Thus, the neighbouring occupancy pattern used to construct contexts for each child can be the same and predefined, and by using the same neighbouring child node occupancy pattern, the construction of context information can be simplified, thereby improve the coding efficiency.

In some embodiments, the contexts of each child node is selected based on child nodes occupancy pattern and/or neighbouring parent nodes' occupancy pattern, and if neighbouring nodes occupancy pattern is used for the selection of entropy coding contexts, the context selection may also depend on the child occupancy index within a node, wherein the index indicates the position of the child node in the node, because that the information provided by the occupancy bit of the 6 neighbours nodes of parent node will not have the same importance in selecting suited entropy coding contexts for coding child volume/node. Thus, by considering the child occupancy index, namely, the position of the child node in a parent node, the importance of each occupancy bit of neighbour node can be distinguished. Preferably, each index is associated with a weight indicating the importance of the neighbour node.

In some embodiments, the storing occupied child nodes at depth d+1 in a lexicographic order is performed by processing each node in 4 passes. Therein, 4 tubes for each node at a depth might be defined. Each tube is formed by corresponding tube of all the nodes having fixed coordinate position in a plane formed by two of the three coordinate axes. Detailed descriptions of the tubes are made with reference to FIGS. 9 and 10 for example. To code all the child nodes of a node, each node is possessed 4 times and each time one of the 4 tubes of the node is traversed.

In some embodiments, the entropy encoding or decoding of the occupancy information of the child nodes of each node into or from a bitstream is based on the lexicographic order of nodes at depth d and a fixed order of the child nodes for a given node. Thus, occupied nodes are processed in raster scan order, but the occupancy bits for all the child volumes of the nodes are successively coded by a fixed order. Compare to the prior art with nodes coded in Morton order, the neighbouring information is more reliable and the coding performance is better due to the adoption of the lexicographic order of scanning.

In some embodiments, the storing of the occupied child nodes at depth d+1 is performed by processing each node in a single pass on all the nodes of obtained nodes, preferably by using intermediate storage to order child nodes in the lexicographic order, preferably raster scan order. For example intermediate lists can be used to order the child nodes within a node in a single pass, thereby it is not necessary to process each node 4 times in order to code all the child nodes. Complexity of the coding is further reduced and it doesn't influence the performance of coding.

In some embodiments, the entropy encoding or decoding of each child node applies a dynamic Optimal Binary Coder with Update on the Fly, OBUF. Thus, due to the additional beneficial effect of dynamic OBUF, it is more efficient in the case that a sufficiently high number of occupancy bits have been coded.

In another aspect of the present disclosure, an encoder is provided for encoding a 3D point cloud into a bitstream. The encoder comprises a memory and a processor, wherein instructions are stored in the memory, which when executed by the processor perform the steps of the method for encoding described before.

In another aspect of the present disclosure, a decoder is provided for decoding a 3D point cloud from a bitstream. The decoder comprises a memory and a processor, wherein instructions are stored in the memory, which when executed by the processor perform the steps of the method for decoding described before.

In another aspect of the present disclosure, a bitstream is provided, wherein the bitstream is encoded by the steps of the method for encoding described before.

In another aspect of the present disclosure, a computer-readable storage medium is provided comprising instructions to perform the steps of the method for encoding a 3D point cloud into a bitstream as described above.

In another aspect of the present disclosure, a computer-readable storage medium is provided comprising instructions to perform the steps of the method for decoding a 3D point cloud from a bitstream as described above.

### BRIEF DESCRIPTION OF THE DRAWINGS

In the following, the present disclosure is described in more detail with reference to the accompanying figures.

FIG. 1 shows Morton ordering of child nodes and occupancy bits, according to an embodiment.

FIG. 2 shows neighborhood made of nodes at same and higher depth than the current node, according to an embodiment.

FIG. 3 shows an example of occupied nodes in a neighborhood involving higher than current depth neighbors, according to an embodiment.

FIG. 4 shows an occupancy map (white cubes) known from previously encoded or decoded occupancy bits when encoding or decoding occupancy bit of a child node (striped cube) using a Morton order, according to an embodiment.

FIG. 5 shows raster scan of voxels, according to an embodiment.

FIG. 6 shows dynamic reduction function DRⁿ based on a tree, according to an embodiment.

FIG. 7 shows evolution of the tree-based dynamic reduction function DRⁿ into DRⁿ⁺¹, according to an embodiment.

FIG. 8 shows always available (a), never available (b) and sometimes available (c) neighbouring child nodes of a current node (solid grey) when using a Morton scanning order, according to an embodiment.

FIG. 9 shows raster scan processing of parent nodes for raster scan coding of the occupancy of their child nodes, according to an embodiment.

FIG. 10 shows coding order of slice0 and slice1 of occupied nodes of same fixed x at current depth, according to an embodiment.

FIG. 11 shows an implementation of the decoder with proposed method, according to an embodiment.

FIG. 12 shows an implementation of the encoder with proposed method, according to an embodiment.

FIG. 13 shows an occupancy map (white cubes) known from previously encoded occupancy bits when encoding occupancy bit of a child node (striped cube) using a raster scan order, according to an embodiment.

FIG. 14 shows an example of neighbouring child occupancy pattern shown in 3D (left) and as 2D layers (right), according to an embodiment.

FIG. 15 shows an example of neighbouring nodes occupancy pattern when coding a child occupancy bit (striped volume), according to an embodiment.

FIG. 16 shows raster scan ordered parents nodes with 8 child occupancy bits coding and raster scan ordering of the child nodes, according to an embodiment.

FIG. 17 shows an implementation of the decoding method using raster scan ordered parents nodes with 8 child occupancy bits coding together, according to an embodiment.

FIG. 18 shows an example of the encoder using raster scan ordered, according to an embodiment.

FIG. 19 shows an occupancy map (white cubes) known from previously encoded or decoded occupancy bits when encoding or decoding occupancy bit of a child node (striped cube) using a raster scan order of the nodes but coding all the bits for the child nodes' occupancy using a Morton order, according to an embodiment.

FIG. 20 shows a block diagram of an encoder with ordering the child nodes into raster scan order by a single pass of a node, according to an embodiment.

FIG. 21 shows a block diagram of a decoder with ordering the child nodes into raster scan order by a single pass of a node, according to an embodiment.

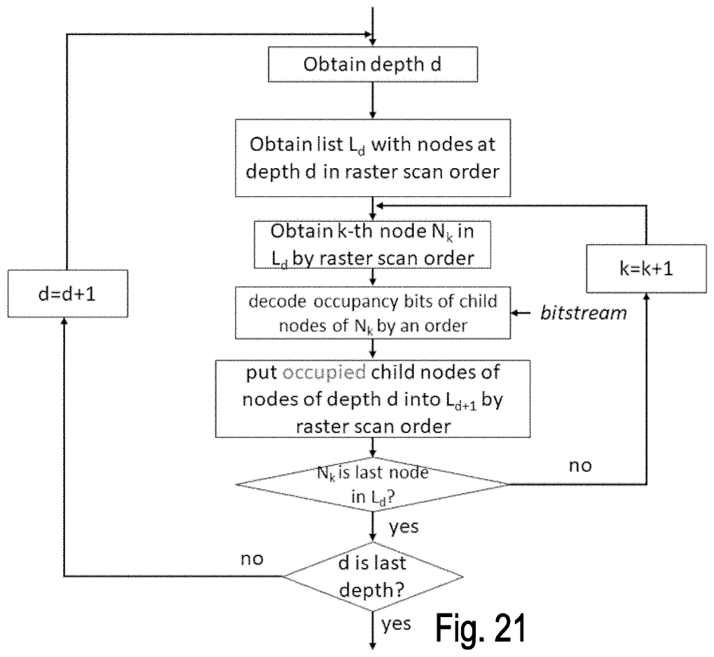

FIG. 22 shows a process to put occupied child nodes of node Nₖ into L_{d+1} in raster scan order, according to an embodiment.

FIG. 23 shows composition of buffer L_{d+1} and buffer Lo of buffer L_{d+1} at depth d, according to an embodiment.

FIG. 24 shows a schematic flow diagram of the method for encoding, according to an embodiment.

FIG. 25 shows a schematic flow diagram of the method for decoding, according to an embodiment.

FIG. 26 shows a schematic diagram of an encoder according to an embodiment.

FIG. 27 shows a schematic diagram of a decoder according to an embodiment.

### DETAILED DESCRIPTION OF THE EMBODIMENTS

Compression may be lossy (like in video compression) for the distribution to and visualization by an end-user, for example on AR/VR glasses or any other 3D-capable device. Other use cases do require lossless compression, like medical applications or autonomous driving, to avoid altering the results of a decision obtained from the analysis of the compressed and transmitted point cloud.

Until recently, point cloud compression (aka PCC) was not addressed by the mass market and no standardized point cloud codec was available. In 2017, the standardization working group ISO/JCT1/SC29/WG11, also known as Moving Picture Experts Group or MPEG, has initiated work items on point cloud compression. This has led to two standards, namely
MPEG-I part 5 (ISO/IEC 23090-5) or Video-based Point Cloud Compression (V-PCC) and
MPEG-I part 9 (ISO/IEC 23090-9) or Geometry-based Point Cloud Compression (G-PCC).

Both V-PCC and G-PCC standards have finalized their first version in late 2020 and will soon be available to the market.

The V-PCC coding method compresses a point cloud by performing multiple projections of a 3D object to obtain 2D patches that are packed into an image (or a video when dealing with moving point clouds). Obtained images or videos are then compressed using already existing image/video codecs, allowing for the leverage of already deployed image and video solutions. By its very nature, V-PCC is efficient only on dense and continuous point clouds because image/video codecs are unable to compress non-smooth patches as would be obtained from the projection of, for example, Lidar-acquired sparse geometry data.

The G-PCC coding method has two schemes for the compression of the geometry.

The first scheme is based on an occupancy tree (octree/quadtree/binary tree) representation of the point cloud geometry. Occupied nodes are split down until a certain size is reached, and occupied leaf nodes provide the location of points, typically at the centre of these nodes. By using neighbour-based prediction techniques, high level of compression can be obtained for dense point clouds. Sparse point clouds are also addressed by directly coding the position of point within a node with non-minimal size, by stopping the tree construction when only isolated points are present in a node; this technique is known as Direct Coding Mode (DCM).

The second scheme is based on a predictive tree, each node representing the 3D location of one point and the relation between nodes is spatial prediction from parent to children. This method can only address sparse point clouds and offers the advantage of lower latency and simpler decoding than the occupancy tree. However, compression performance is only marginally better, and the encoding is complex, relatively to the first occupancy-based method, intensively looking for the best predictor (among a long list of potential predictors) when constructing the predictive tree.

In both schemes, attribute (de)coding is performed after complete geometry (de)coding, leading to a two-pass coding. Thus, low latency is obtained by using slices that decompose the 3D space into sub-volumes that are coded independently, without prediction between the sub-volumes. This may heavily impact the compression performance when many slices are used.

An important use case is the transmission of dynamic AR/VR point clouds. Dynamic means that the point cloud evolves with respect to time. Also, AR/VR point clouds are typically locally 2D as they most of time represent the surface of an object. As such, AR/VR point clouds are highly connected (or said to be dense) in the sense that a point is rarely isolated and, instead, has many neighbours.

In GPCC, despite the reduction of the neighborhood to adjacent neighbors, the number of possible configurations is still too high to be used directly in selecting the context that will be used for entropy coding the occupancy information of the current node.

Several techniques have been proposed to further reduce the neighborhood configurations to an implementable number of reduced configurations.

Firstly, some “physical” arguments have been introduced like the masking of an occupied neighbor by another occupied neighbor placed between the former and the current node; in this case the information of the former is discarded because this information is supposed to be weaker than the information of the latter.

Secondly, based on learning, reductions by look up table(LUT) have been proposed reduced configuration=LUT[configuration]

where the range of output of the LUT is lower than the number of entries. The construction of the LUT depends much on the type of learned point cloud. During the coding of occupancy of child node, LUT is used. The LUT is a look up table of coder indices based on the occupancy information configurations of current encoded child node, and it maps occupancy information configurations to select a coder index and the selected binary coder is used to encode current child node.

Thirdly, a more flexible technique named Optimal Binary Coder with Update on the Fly (OBUF) has been introduced to reduce the number of contexts of the entropy coder (like CABAC) by
using a limited number of adaptive entropy coders (say 32)
associating a coder index (say 0 to 31) with each neighborhood configuration
after each coding of the occupancy of a current node, updating the coder index associated with the neighborhood configuration of the current node

OBUF has been combined with the first two reduction techniques, applied before OBUF, to limit the number of coder indices that are dependent on reduced configurations.

It has also been proposed to allow the practical implementation of entropy coding the occupancy bit of a current geometry element by using the al-ready-coded occupancy information of neighbouring nodes by
reducing the neighbourhood occupancy configuration using easy-to-compute low-memory reduction functions
using reduced configurations as input of a LUT pointing to a small set of entropy coders; updating this LUT after the coding of the occupancy bit. This is the so-called OBUF process in the prior art.
entropy coding the occupancy bit using an entropy coder pointed by the entry of the LUT indicated by the reduced configurations This process is very efficient once a sufficiently high number of occupancy bits have been coded such that the LUT has been updated enough times to converge and to point consistently to entropy coders having coding probability well correlated with the reduced configurations.

However, when points clouds are small or at the start of the coding process of big point clouds, the OBUF LUT has not converged yet and cannot select an adequate entropy coder. This leads to bad compression of small point clouds or to degraded compression of big point clouds.

In a 3D octree representation of the geometry of the point cloud, the number of possible occupancy configurations of the neighbourhood is 2N where N is the number of nodes/voxels involved in the neighbourhood. This number becomes very large even when a low number N of neighbours is involved.

Therefore, it has been proposed to add an extra step of reduction after an (optional) fixed reduction function. This new reduction will be called a “dynamic reduction” that is updated depending on the progress of the coding of the point cloud.

A typical example of order of magnitude of the size of involved contextual information is as follows when dealing with neighbourhood in an octree representing the geometry of the point cloud.

There are 26 neighbouring nodes sharing a face, an edge or a vertex with the parent of the current node whose occupancy bit is to be coded. When using a breadth-first scanning of the octree, all occupancy bits of these 26 neighbouring nodes are already coded and can be used as contextual information.

Depending on the scanning order (Morton order of raster scan order), most of the time at least 7 of the 26 neighbouring nodes have already had their children's occupancy bits being coded. This adds 8*7=56 occupancy bits that can be used as contextual information.

Finally, part of sibling nodes of the current node may have already been coded. They are at most 7. So, all in all, up to 26+56+7=89 already-coded occupancy bits may be used as contextual information, just by considering closest neighbours touching the current node. This leads to 289~10009=1027 possible neighbourhood configurations used as contextual information.

Not all these configurations are visited when coding a point cloud. However, they must be kept to cover a wide variety of point clouds. For example, coding an AR/VR dense point clouds would lead to some reduced contextual configurations to be visited, but coding a Lidar sparse point cloud would lead to other reduced contextual configurations to be visited. That is primary goal of the dynamic reduction: further reduce configurations that are rarely or never visited and give full potential (i.e. no or weak reduction) to configurations that are visited often. The dynamicity comes from the on-the-fly determination of the often-visited configurations during coding and to the update of the function of dynamic reduction based on this determination.

So, basically, the function DR of dynamic reduction is initialized with an initial function DRO with maximum reduction of all configurations, and then is updated into DR¹, DR², . . . , DRⁿ, etc. Each update depends on the visited configurations during coding and is determined by relaxing the reduction on often visited configurations. One obtains a tower of functions DR with increasing image size which is equal to the number of possible output dynamically reduced configurations.
#Im DR⁰≤#Im DR¹≤ . . . ≤#Im DRⁿ≤#Im DRⁿ⁺¹≤ . . .

It has been further proposed to construct the function DR of dynamic reduction that works by keeping a certain of bits of a contextual information CI. Let us suppose that the contextual information CI is a word made of a series of K bits
CI=β1. . . βK

The dynamic reduction function DRⁿ may then simply be defined by keeping the first kₙ(CI) bits of CI such that the dynamically reduced contextual in-formation CI′ is
CI′=β1 . . . βkn(CI)
   and the function DRⁿ is entirely defined by the array kₙ(CI). The value of k0 may be initialized to zero
kₙ(CI)=0
   and the update from DRⁿ to DRⁿ⁺¹ is performed by changing the array kₙ(CI) into a new array kₙ₊₁(CI). This change is made by increasing the number of kept bits.
kₙ(CI)≤kₙ₊₁(CI).

The iterative construction (over n) of a series of dynamic reduction functions DRⁿ has been proposed based on the construction of a binary tree. The initial function DR^{N}=0 corresponds to a tree having only a root node.

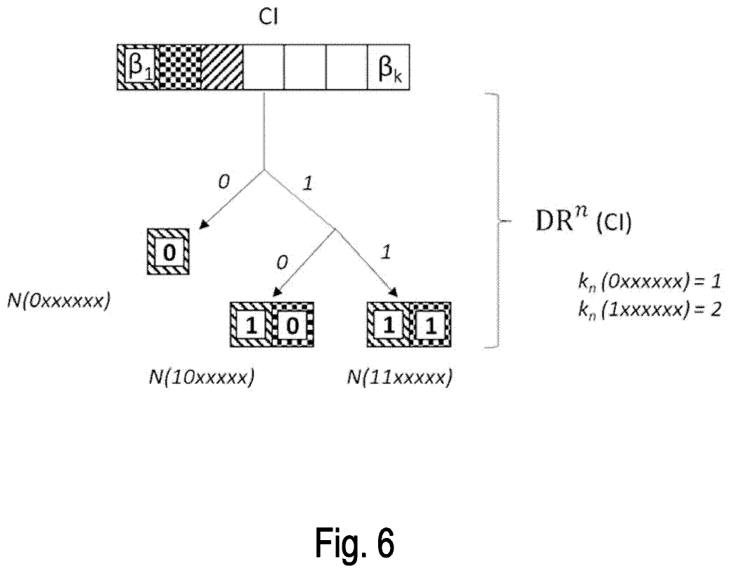

An exemplary function DRⁿ is depicted in FIG. 6. It is defined by a binary tree. The choice of each branch of the tree, from a node at depth d, is made depending on the value (0 or 1) of the d-th bit βd of the contextual information CI. Leaf nodes corresponds to dynamically reduced configurations.

As seen on the exemplary tree of FIG. 6, there are three dynamically reduced configurations corresponding to contextual information CI having binary form 0xxxxxx, 10xxxxx and 11xxxxx. to these three configurations are attached three numbers N(0xxxxxx), N(10xxxxx) and N(11xxxxx) that tracks the number of visits, up to now, during the progress of the coding of the point cloud. These numbers count the number of visits to each reduced configuration CI′ during coding.

Because a binary representation kₙ(CI) of the function DRⁿ is used, this function may be represented by the array kₙ(CI) as follows
kn (0xxxxxx)=1 and kn (1xxxxxx)=2.

The function DRⁿ evolves into an updated function DRn+1 when a number N exceeds a threshold th.

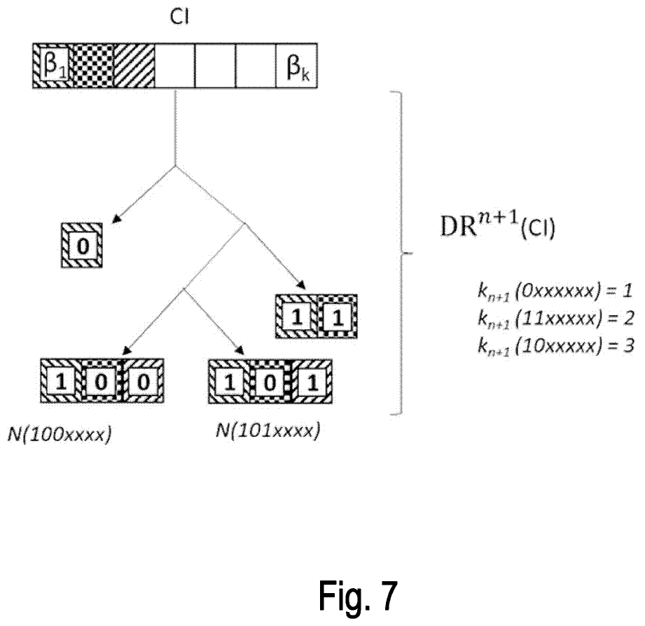

FIG. 7 depicts the updated function DRⁿ⁺¹ in case N(10xxxxx) has exceeded the threshold th.

The tree has been prolonged from the node corresponding to the configuration 10xxxxx to two sub-nodes corresponding to the configuration 100xxxx and 101xxxx. In the general case, when N(C) exceed the threshold for a configuration C, the node corresponding to the configuration C is prolonged into two sub-nodes associated with two new configurations replacing the configuration C. The two new configurations involve one more bit after reduction.

After update, the function DRⁿ⁺¹ may be represented by the array kₙ(CI) as follows
kₙ (0xxxxxx)=1, kₙ (11xxxxx)=2 and kₙ (10xxxxx)=3.

However, according to the existing techniques, there is still rooms to improve the coding efficiency. In particular, child occupancy of each node is coded by Morton order and the encoding order of the node is also in Morton order.

Therefore, there are at least 2 drawbacks in prior art which will be described below:

First, in the prior art, when considering the coding of the child occupancy of a current node, not all neighbouring child volume occupancy have been already coded. Therefore, the occupancy information of some child volumes of neighbouring nodes is missing. The explanation is described below.

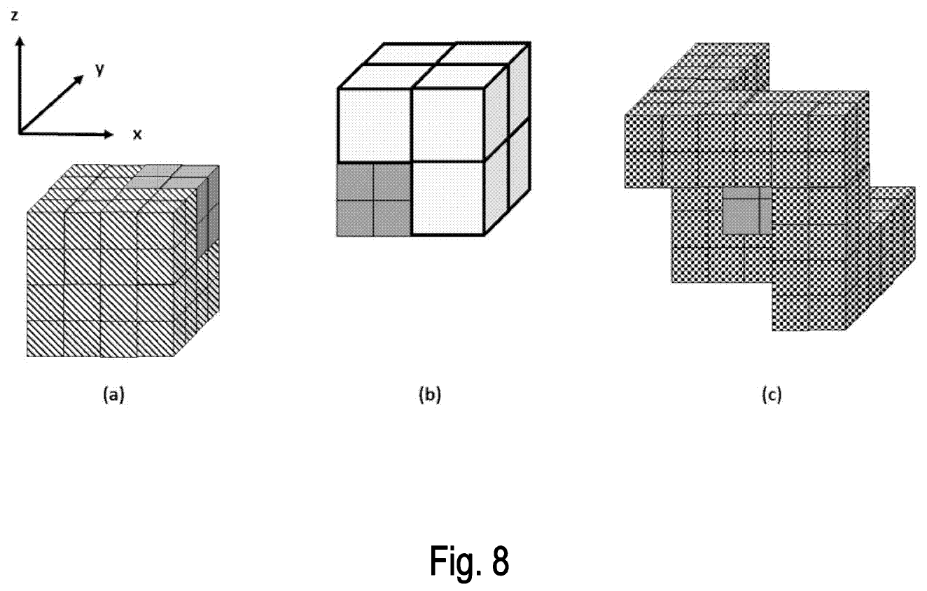

With breadth-first Morton scanning order, available neighbouring child nodes are as depicted on FIG. 8. The occupancy of the child nodes of the 7 neighbouring nodes in the lower xyz coordinate corner (a) have always been already coded and so is available. However, the occupancy of the child nodes of the 7 neighbouring nodes in the higher xyz coordinate corner (b) have never been already coded and so is not available. In between, the occupancy of the child nodes of the remaining 12 neighbouring nodes may or may not be already coded and so may or may not be available.

The availability of the occupancy of these 12 neighbouring nodes depends on the position of the current node into the octree and of its corresponding Morton code. In particular, at first order, it depends on the position of the current node in its parent node.

Thus, one of the major drawbacks of using Morton order is the neighbour pattern used to determine entropy contexts or to make prediction may vary a lot with different child volume position in the Morton order. It complexify the design of an efficient entropy coding of the occupancy tree and may also lead to suboptimal compression.

Second, one known advantage of using Morton ordering (or some other space filling curves which are known to do similar) is that this order tends to allow processing nodes which have close distance in 3D, with a close distance within the 1D Morton order (i.e. distance between the Morton codes/indexes). Of course, this is only a tendency.

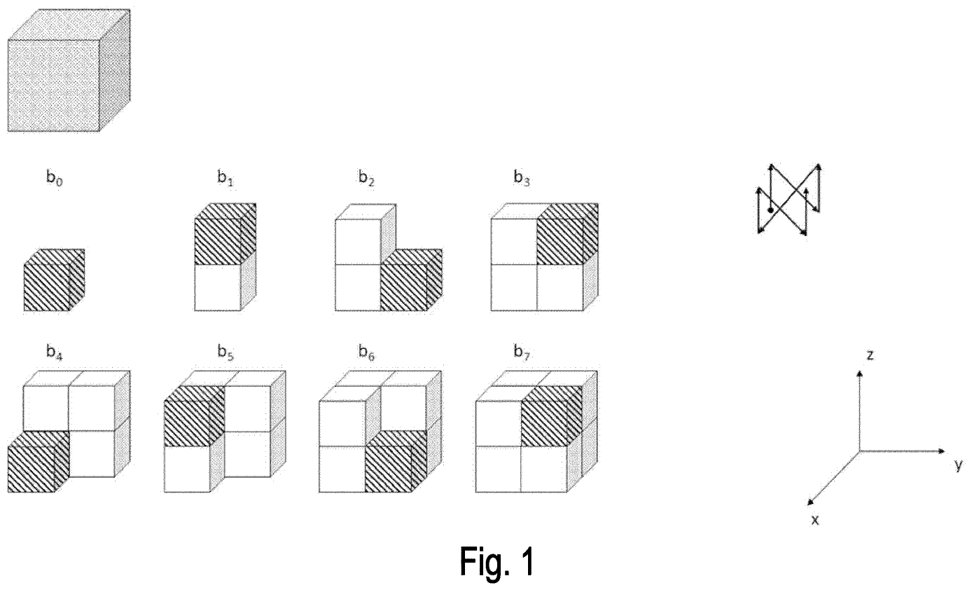

However, there are exceptions, where two nodes at some depth may be close in 3D but really far in 1D Morton order, this may occur for instance when the nodes are close but opposite to the centre of a bigger node. In one example a first voxel belongs to the volume corresponding to b0 in FIG. 1 in the root node and this first voxel is close to the centre of the root node; a second voxel belongs to the volume corresponding to b7 and is also close to the centre of the parent node. In an extreme case both voxels could be so close that they would share an edge, but after few depths in the octree traversal, the Morton codes associated to the refined nodes containing these voxels are becoming distant in the 1D Morton order.

For example, there are 2 points (x0, y0, z0) and (x1, y1, z1), and point (x0, y0, z0)=(255, 255, 255), point (x1, y1, z1)=(256, 256, 255), and they can be represented in binary as (x0, y0, z0)=(255, 255, 255)=(011111111b, 011111111b, 011111111b), (x1, y1, z1)=(256, 256, 255)=(100000000b, 100000000b, 011111111b) From combing their first bit value of three coordinates, which is 000b point (x0, y0, z0) and 110b for point (x1, y1, z1), then we can get point (x0, y0, z0) belongs to b0 node and point (x1, y1, z1) belongs to b6 node in the root node. As shown in FIG. 1, they share the same edge.

And the Morton code for them can be:
m0 000111111111111111111111111b=16 777 275
m1=110001001001001001001001001b=103 060 041

Then the Euclidian distance in Cartesian space can be

\sqrt{2*(256−255)²}=2^{1/2}≈1,4142,

and the Euclidian distance in Morton code space can be

\sqrt{(103 060 041−16 777 275)²}=86 282 766,

so the Morton codes associated to the refined nodes containing the 2 points are becoming more distant in the 1D Morton order.

In G-PCC's occupancy tree, each node of the tree represents an occupied cubical volume of a size/volume which can be determined from the depth in the tree. The occupancy is coded depth per depth in the tree, starting from the root node representing the complete volume of the point cloud. In other words, the occupancy tree is encoded and decoded using a breadth first traversal of the tree. Limiting our description to an octree representation (without direct coding mode enabled) for the sake of simplicity, each depth in the octree provide twice precision in each of the three dimensions. At a given depth (d) of the tree, all nodes of the tree are processed following a Morton order on their coordinates. For each node, the occupancy of 8 sub-volumes at next depth is coded, representing 2×2×2 child volumes, and the child volumes indicated as occupied provides child nodes in the next depth of the tree.

In case a quadtree splitting is used at a given depth level (d), the occupancy of the sub-volumes at next depth becomes 2×2×1, 2×1×2 or 1×2×2 child volumes (i.e. 2D); and the processing order of the child nodes at next depth (d+1) then becomes the coding order used for their parent nodes (i.e. nodes at depth d) refined by their Morton order in this 2D space (i.e. the Z-scan order along the two split directions). In case a binary tree splitting is used, the occupancy becomes 2×1×1, 1×2×1 or 1×1×2 child volumes (i.e. 1D); and the processing order of the child nodes at next depth then becomes the coding order used for their parent nodes refined by their Morton order in this 1D space (i.e. the lexicographic order along the split direction).

Basically, for processing the nodes following a Morton ordering, a queue structure of the nodes can be used. The process starts from a queue containing a single node (the root node corresponding to the complete point cloud volume). Then, while the queue is not empty, the node at the beginning (front) of the queue is removed, the occupancy of its child volumes is coded, and if these child volumes are not leaf nodes, child nodes for the occupied child volumes are appended at the end (back) of the queue, following their respective Morton order. Thus, the queue structure acts like a first in first out (FIFO) buffer: firstly pushed child nodes will be firstly coded when processing next depth.

FIG. 1 illustrates the 8 possible child nodes of a parent node, ordered in Morton order. The occupancy bits b0 to b7 indicates the presence or the absence of points in each one of the corresponding sub-volumes. These bits are coded while processing the parent node, and the node corresponding to the occupied child nodes are appended to the processing queue.

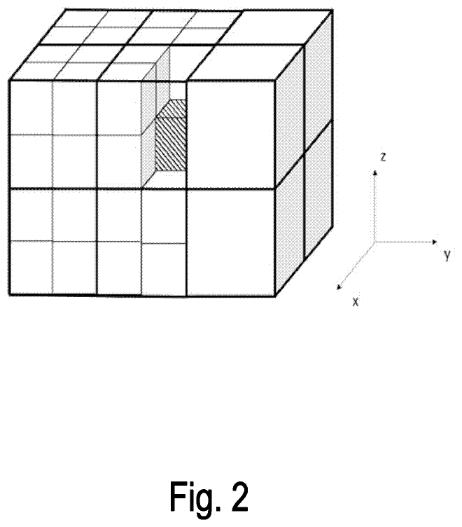

In an octree representation of the point cloud, if nodes are processed in a depth first order as in MPEG GPCC, one may profit from the knowledge of the occupancy of nodes at higher depth as explained on FIG. 2.

Nodes at depth higher than the current node are used to obtain geometry information in regions (here for y higher than the y of the current node) not yet coded at current depth.

In MPEG G-PCC, a combination of neighboring nodes at current depth and current depth plus one are used to define a neighborhood. However, in order to limit the number of possible neighborhood configurations, the neighborhood has been limited to a subset of the set of nodes adjacent to the current node.

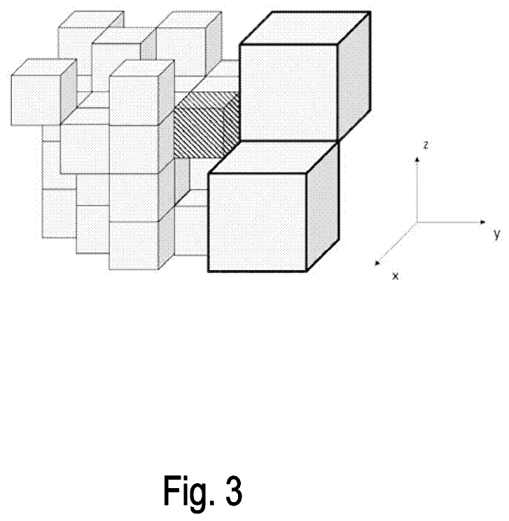

FIG. 3 depicts an example of neighborhood, for which only occupied nodes have been drawn, when neighboring nodes of depth higher than the current depth are also involved.

When using a breadth-first scanning order, one understands that the occupancy of all neighboring nodes at same depth as the current node is always known, when coding children occupancy, because it was coded at the preceding depth.

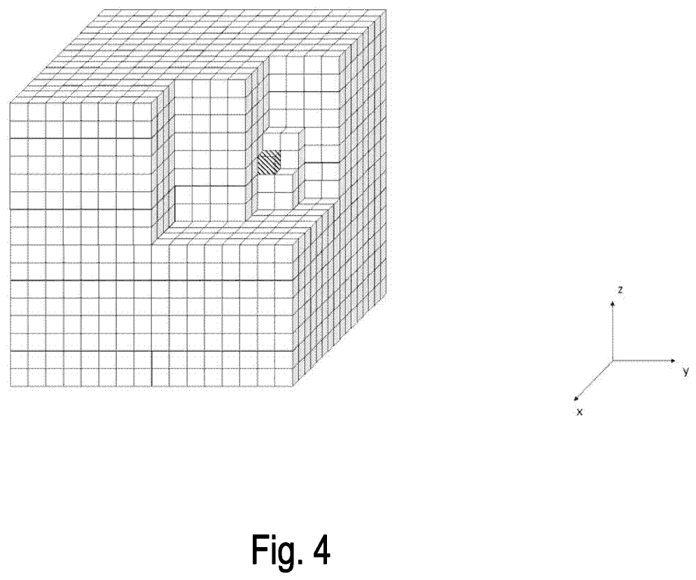

FIG. 4 shows the volume (made of white cubes) in which the occupancy at a given depth is known when performing the coding of an occupancy bit for a current child node (striped cube) in case nodes are processed in Morton order and occupancy bits are also coded in Morton order. From this figure it may be also understood the nature of the different sub-volumes that could be mapped within an occupancy atlas.

Raster scan order is usually used to code the attributes (a grey level or 3 channels of color for instance) of a dense content for which geometry does not need to be provided: the geometry covers the full surface of the image (in case of 2D) or the full volume (in case of 3D, biomedical images, or video content for instance).

In some embodiments, a mask is provided. The mask defining a region of interest to which the attributes coding is limited. The coding of this mask could be assimilated as the coding of the geometry occupancy in a point cloud. In some embodiments, simply code the mask by successively encoding a bit for every possible voxel position in the considered volume using a raster scan order and contextual entropy coding, each bit indicating if the corresponding voxel is occupied or not (and so if the attributes is coded for that voxel position or not).

In 2D a raster scan order of the pixels is just a lexicographic ordering of the pixels according to their 2D coordinates x and y. A lexicographic order in (y, x) is usually used on images: pixels processing is ordered first by x then by y; pixels are ordered by increasing x coordinates for a given y coordinate and by increasing y coordinate. A 3D raster scan order is similar but in three-dimensional space (i.e., 3D raster scan order is a lexicographic order on an arrangement of the 3D coordinates.). A raster scan order of the voxels just follows a lexicographic order but in the three dimensions x, y, and z, for instance a lexicographic order in (z, y, x) may be used for volumetric images (or t, y, x for temporal sequences of images like in video).

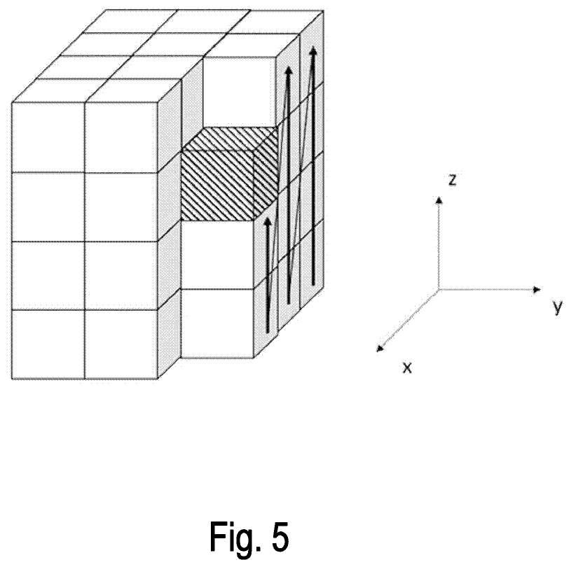

As shown in FIG. 5, in a voxel representation of the geometry of a point cloud, voxels (=3D volume associated with a single point) may be scanned in a raster scan order as depicted in FIG. 5.

In FIG. 5, the order shown follows a raster scan firstly in y, secondly in x and finally in z. This is the lexicographic order in xyz. And FIG. 5 shows a causal neighbourhood (made of already coded nodes/voxels: white cubes) of a current node/voxel (hashed cubes) to be coded. The occupancy of the already coded neighbours is known and may be used to predict and code the occupancy of the current node/voxel. Already coded nodes/voxels are those whose lexicographic order is lower than the order of the current node/voxel.

The proposed method encodes/decodes the child volume occupancy bits based on nodes in raster scan order at a given depth in the occupancy tree. In one embodiment of the proposed method, it uses raster scan order of the child volumes to code/decode their respective occupancy bits; In another embodiment of the proposed method, it uses the raster scan order of the nodes to code/decode the occupancy bits of all their respective child volumes (together).

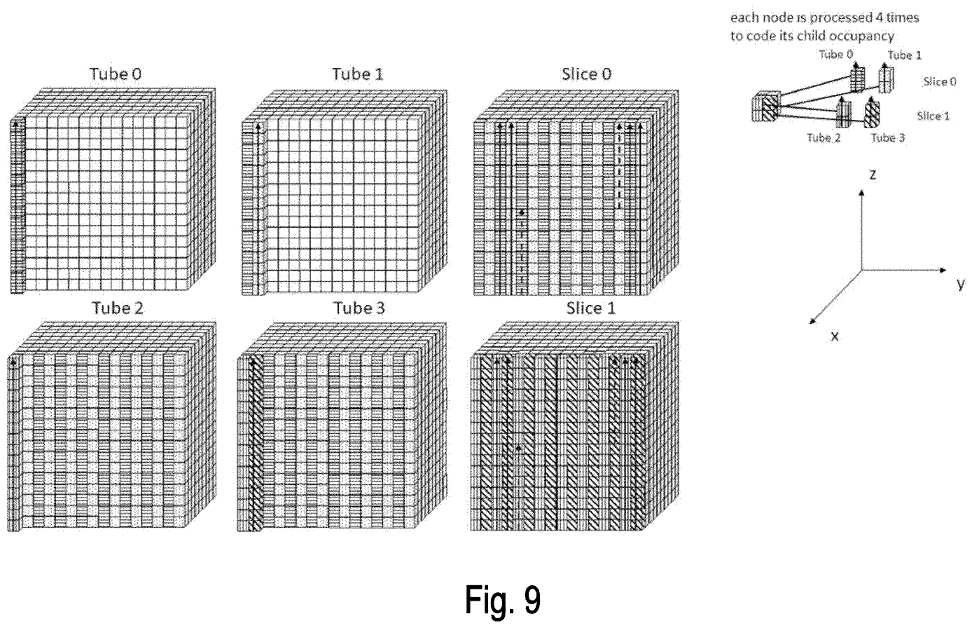

In one embodiment, the proposed method is illustrated in FIG. 9. For a better understanding, the full occupancy volume is represented in the figure, to better see the raster scan order of the processing. But one should understand that some part of the volume will not be coded/processed if ancestors' nodes have been indicated as unoccupied.

As shown in FIG. 9, a lexicographic order in (x, y, z) (i.e. a colexicographic order in (z, y, x)) is used. For a given depth in the octree, the child nodes' occupancy is coded following the raster scan order of the child nodes. To achieve raster scan order of child nodes, 4 tubes (tube 0, tube 1, tube 2, tube 3) for each node at current depth are defined, each tube being made from every node with a same x and y. And coding the occupancy bits of child nodes of tube 0 is performed by coding the occupancy bits b0 then b1 of all the occupied nodes with same fixed x and y, and the nodes being ordered by increasing z of all the occupied nodes. The coding of the occupancy tube 1 is then performed, by coding the occupancy bits b2 then b3 of the same nodes, and in the same order as for tube 0.

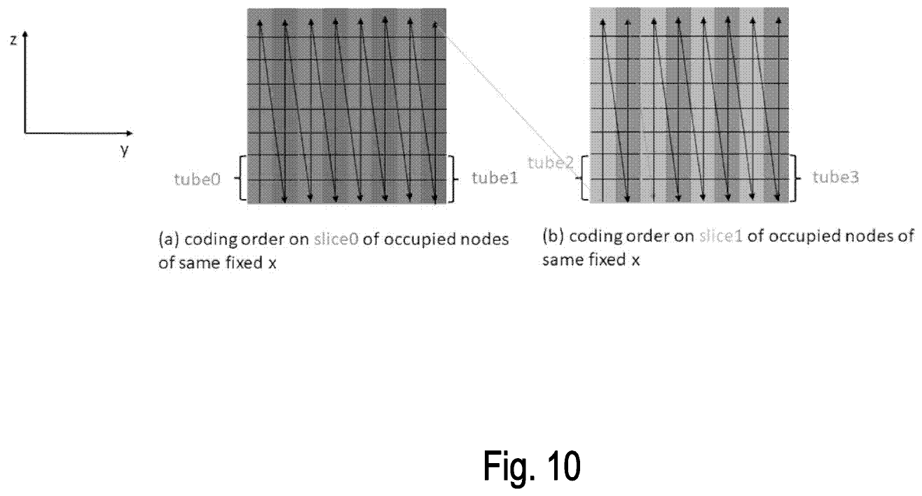

The coding process for coding occupancy tube 0 of all the occupied nodes with same fixed x and y and occupancy tube 1 of all the occupied nodes with same fixed x and y is repeated for every y, in increasing y order. It provides a raster scan coding of the slice0 made of every bit b0, b1 b2, b3 of all the occupied nodes with same x. The illustration of raster scan order of slice0 of these nodes is shown in FIG. 10(a), wherein each child node is represented in 2D to better illustrating. After coding the slice0 of the nodes at a fixed x, then it codes the slice1 of these nodes at same x and the coding process of slice0 is reproduced for slice1, by successively coding in the same order, the occupancy tubes 2 then 3 made of occupancy bits b4 and b5 then b6, b7 of the same nodes. And the coding process of the illustration of raster scan order of slice1 of these nodes is shown in FIG. 10(b) wherein each child nodes are represented in 2D to better illustrating. The coding process of slice0 then slice1, is repeated for every x of nodes at current depth, in increasing order, of all the occupied nodes.

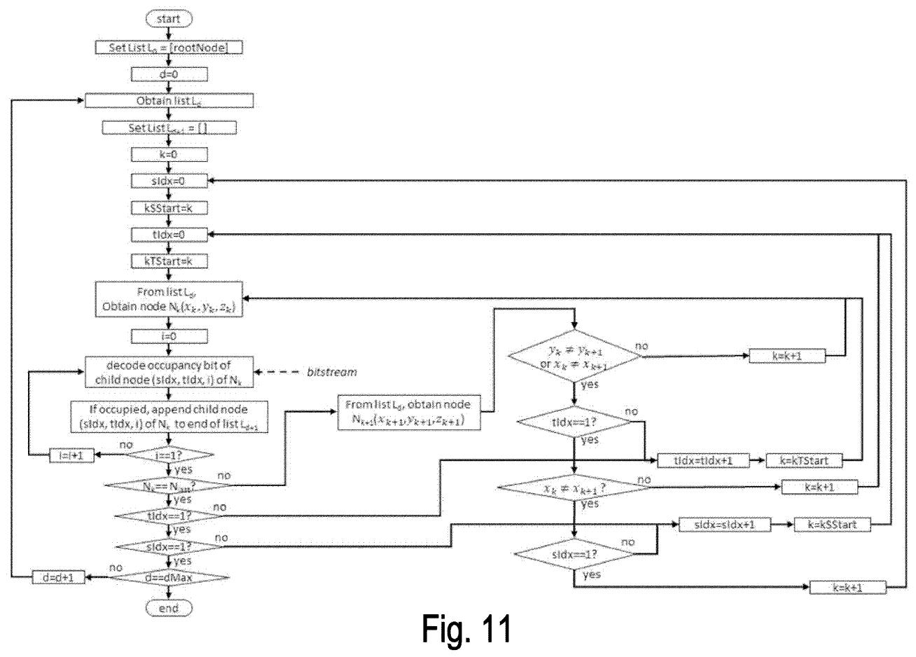

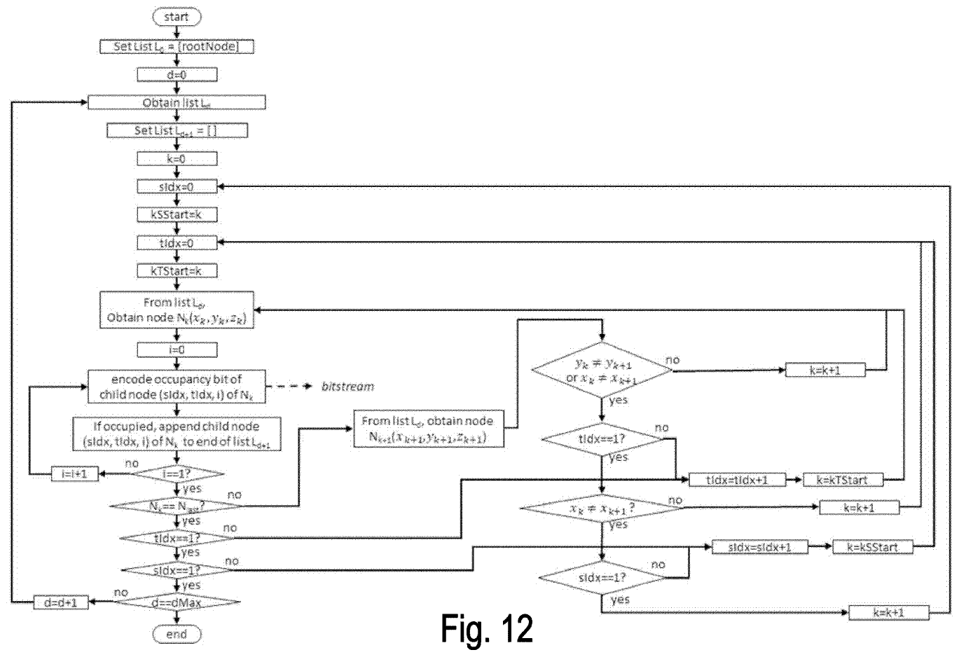

One embodiment of the decoder with proposed method is shown in FIG. 11 as a block diagram, wherein a list La represents a list containing nodes Nₖ(xₖ, yₖ, zₖ) at a depth d in the octree, the nodes being ordered in raster scan order from N₀ to Nₗₐₛₜ, and k being the order index of the node in the list L_{d}. The FIG. 12 shows both
the process to decode occupancy of the child nodes (sIdx, tIdx, i) at depth d+1 from bitstream following raster scan order
and the process to put child nodes into list L_{d+1} to generate raster scan ordered nodes for next depth.

The variable sIdx represents the index of a slice of all the occupied nodes with a same x; the variable tIdx represents the index of a tube of all the occupied nodes with a same x and y; and the variable i represents the index of a child within each tube.

In other words, the integer value obtained from the binary word formed by (sIdx, tIdx, i) is the child index of a node (a decimal value from 0 to 7).

The variable kSStart is used to store the order index of the first node of a slice of all the occupied nodes with a same x; and the variable kTStart is used to store the order index of the first node of a tube of all the occupied nodes with a same x and y.

The depth dMax is the maximum depth in the tree and can be determined from the bitstream.

The detailed process in decoder can be described as below:
To Initialize the algorithm, by set the list Lo to contain only the root node of the occupancy tree, and set the initial depth d to 0.
Label0
Obtain a (fifo) list L_{d} which stores nodes at depth d in raster scan order
Obtain an empty list L_{d+1} to produce raster scan ordered child nodes used for decoding of next depth;
Set node index k as 0 (initialize variable k with value 0)
Label1:
Set slice index sIdx as 0 (initialize variable sIdx with value 0)
Set first node index in the slice as k (initialize variable kSStart with value of k)
Label2:
Set tube index tIdx as 0 (initialize variable tIdx with value 0)
Set first node index in the tube as k (initialize variable kTStart with value of k) Label3:
Obtain node Nₖ(xₖ, yₖ, zₖ) from list L_{d};
Set child index in the tube as 0 (Initialize variable i with value 0)
process0: decode and generate ordered child nodes for the child nodes in tube tIdx of slice sIdx of the node Nₖ in L_{d}.
   decode occupancy bit of the i-th child of tube tIdx of slice sIdx (which is child node (sIdx, tIdx, i) of Nₖ) from bitstream
   If the the decoded bit indicate that the child is occupied, append a new node for the i-th child of tube tIdx of slice sIdx (which is child node (sIdx, tIdx, i) of Nₖ) at end of list L_{d+1}. This new node has coordinates (2×xₖ+sIdx, 2×yₖ+tIdx, 2×zₖ+i).
   If i is not equal to 1, increase i and repeat the process0, else got to next step
Judge if Nₖ is last node of depth d (i.e. last node of list L_{d}):
   If Nₖ is not last node of depth d, obtain next occupied node Nₖ+1(xₖ₊₁, yₖ₊₁,zₖ₊₁) from list L_{d}. Then judge if xₖ≠xₖ₊₁ or yₖ≠yₖ₊₁
      If xₖ≠xₖ₊₁ or yₖ≠yₖ₊₁, it means the next node does not belong to the same tube of occupied nodes having same x and same y. (Then judge if tIdx==1
         If tIdx==1 it means the processing of the two tubes of child nodes (in a tube of all occupied nodes with a same x and y) of the current slice of child nodes has been finished. Then judge if xₖ≠xₖ₊₁
         If xₖ≠xₖ₊₁ it means the next node does not belong to the same slice of occupied nodes having same x. Then judge if sIdx==1
         If sIdx==1 it means the processing of the two slices of child nodes (in a slice of all occupied nodes with a same x) has been finished. Nₖ₊₁ is thus the starting point of the next slice of occupied nodes, and of next tube of occupied nodes to be processed.
         Increase k by one and loop to Label1 to start processing the first tube of child nodes of the first slice of child nodes of the next slice of occupied nodes.
         Otherwise sIdx==0. It means we can start processing the second slice of occupied nodes.
         Label4:
         Increase slice index sIdx by 1 and reset k to the index of the first node of the slice of all the occupied nodes with a same x: k=kSStart.
         Loop to Label2 to start processing the third tube of child nodes.
         Otherwise xₖ==xₖ₊₁. it means the next node belongs to the same slice of occupied nodes, but to next tube of occupied nodes. Nₖ₊₁ is thus the starting point of the next tube to be processed.
         Increase k by one and loop to Label2 to start processing the first tube of child nodes (belonging to the current slice sIdx of child nodes) of the next tube of occupied nodes.
         Otherwise tIdx==0. It means we can start processing the second tube of child nodes of the current slice of child nodes.
         Label5:
         Increase tube index tIdx by 1 and reset k to the index of the first node of the tube of all the occupied nodes with a same x and y: k=kTStart.
         10 Loop to Label3 to start processing the second tube of child nodes.
      Otherwise xₖ==xₖ₊₁ and yₖ==yₖ₊₁. It means the next node belongs to the same tube of occupied nodes. Increase k by one and loop to Label3 to continue processing the same tube of child nodes.
   Otherwise Nₖ==Nlast, the node is the last node at depth d. Then judge if tIdx==1.
      If tIdx==1 it means the processing of the last tube of child nodes of the current slice of child nodes has been finished. And next slice of child nodes (if remaining) may to be processed. Then judge if tIdx==1.
         If sIdx=32 1 it means the processing of the last slice of child nodes of the last slice of occupied nodes has been finished. And next depth in the occupancy tree (if remaining) may to be processed. Then judge if d==dMax.
         If d==dMax, it means the last depth of the occupancy tree has been decoded. The occupancy tree is then completed.
         Otherwise, d<dMax. It means the next depth of the occupancy tree can be processed. Increase depth d by one and loop to Label0 to process next depth in the occupancy tree.
         Otherwise sIdx==0. It means the processing of the second slice of child nodes of the last slice of occupied nodes may be started. Go to label4 to start it.
      Otherwise tIdx==0. It means the processing of the last tube of child nodes of the current slice of child nodes may be started. Go to label5 to start it.

In an embodiment, the List L_{d+1} can be omitted, and the child nodes are not appended to that list when d==dMax, because the list will not be used since no more depth will be processed.

The coordinates of a child node are the coordinates of its parent nodes refined by one bit of precision. In other words, some physical spatial coordinates of the center of a node could be obtained by multiplying the coordinates of the center of the node by the physical dimensions of the node's volume scaled according to the depth: ((xₖ, yₖ, zₖ)+(0.5, 0.5, 0.5))×(width, length, height)/2^{depth}.

In an embodiment, when d==dMax, if child nodes are occupied, points with coordinates ((2×xₓ+sIdx, 2×yₖ+tIdx, 2×zₖ+i)+(0.5, 0.5, 0.5))×(width, length, height)/2^{dMax} are output (for instance in a buffer). It produces raster scan ordered points geometry.

From the above coding process of child nodes, it is observed that each node Nₖ needs to be accessed/processed 4 times: the first time it is accessed/processed is for coding the occupancy tube 0, the second time is for coding the occupancy tube 1, the third time is for coding the occupancy tube 2 and the last time is for coding the occupancy tube 3.

The mentioned orderings of the nodes Nₖ that are needed by this coding process to build a raster scan ordering of the child nodes occupancy are already obtained from the raster scan ordering of the processed nodes. And the raster scan ordering of the nodes is directly obtained from the raster scan ordering of the child nodes occupancy coding made for parent nodes (i.e., during the previous depth of the octree occupancy coding).

Similarly, one embodiment of the encoder with proposed method is shown in FIG. 12 as a block diagram.

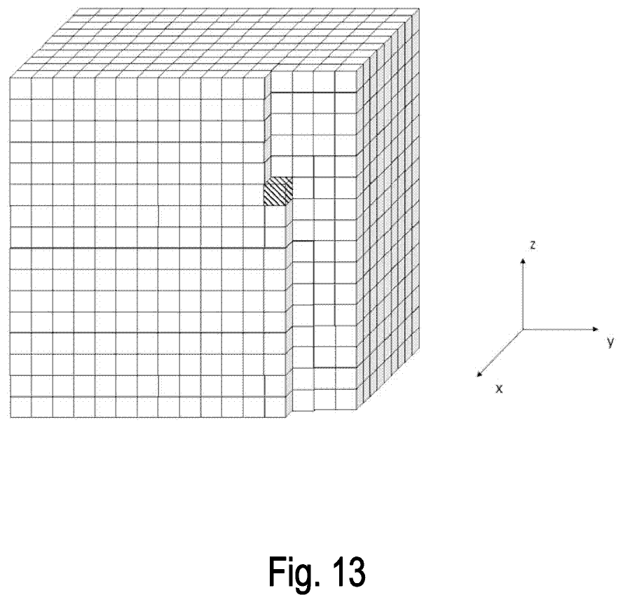

The effect of the proposed method is shown in FIG. 13, which shows the occupancy map coverage of child volumes already known when coding the occupancy bit for the striped child volume, when the occupancy bits are coded following raster scan order of the child volumes of the nodes. FIG. 13 also permits to see the neighbouring positions that can be used to build contexts for entropy coding of the occupancy bit. With the raster scan ordering (whatever is the axis ordering used in lexicographic order), the occupancy of any child volume with a lower z, a lower y or a lower x position may be used for contextualization. A predetermined pattern of neighbouring child volumes may thus be defined and can be used to select coding context for any coded occupancy bit.

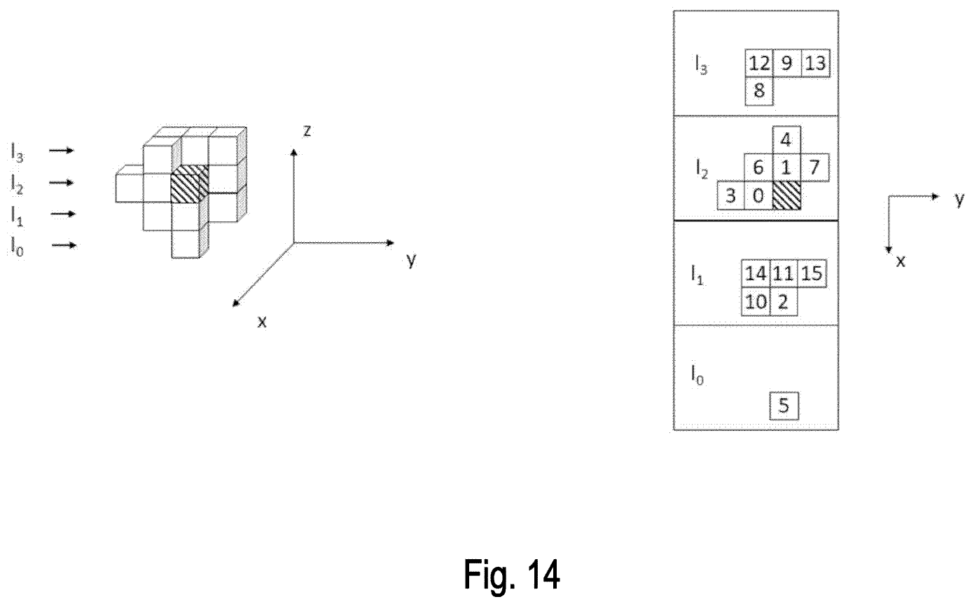

In some embodiments, when coding each child by entropy coding in raster scan order, the neighbouring occupancy pattern used to construct contexts for each child can be the same. As an example of neighbouring occupancy pattern, FIG. 14 provides an example of child neighbouring occupancy pattern (occupancy of white sub volumes) which could be used to determine entropy coding contexts for coding occupancy bits for the striped child volume, when child occupancy is coded by raster scan order. On the left, this neighbourhood is represented in 3D, and on the right, it is represented as 2D layers. In one example, each number on the right may be used to order the occupancy bits from the most important/significative one (position 0) to the least important/significative one (position 15) for it use with a dynamic OBUF, which has been described previously. This would result in 65536 entropy contexts. In some embodiments not using dynamic OBUF, the number of neighbours could be limited to the positions 0 to 11 for instance, to reduce the number of contexts to 4096.

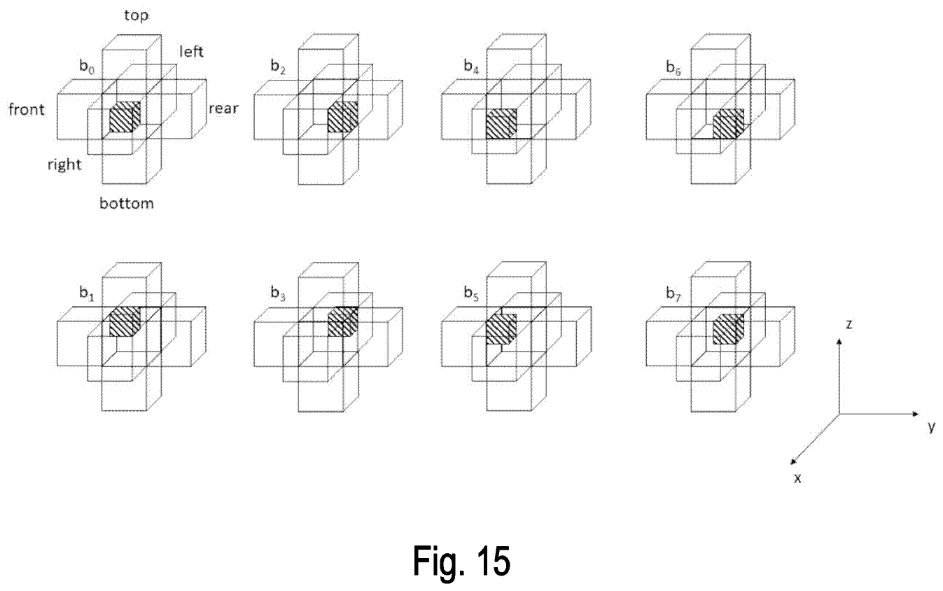

FIG. 15 shows the neighbouring pattern made of the 6 direct neighbours (nodes sharing a face) of a node when coding the different occupancy bits of the child volumes of a current node. As in the prior art, with Morton ordering, neighbouring parent nodes occupancy may provide useful information for improving compression efficiency.

Even if with raster scan coding of child volumes, occupancy neighbouring of the same child occupancy pattern may be used with for coding any one of the child volumes occupancy bits, as can be understood, depending on the position of the child volume, the information provided by the occupancy bit of the 6 neighbours volumes/nodes of parent node will not have the same importance in selecting suited entropy coding contexts for coding child volume. Thus, if neighbouring nodes occupancy is used for the selection of entropy coding contexts, the context selection may also depend on the child occupancy index. This also applies to the use of other neighbours, for instance the 36 neighbours, made of any neighbouring node/volume having at a shared face, edge or wedge with current node are used in the modelling of an entropy coding context.

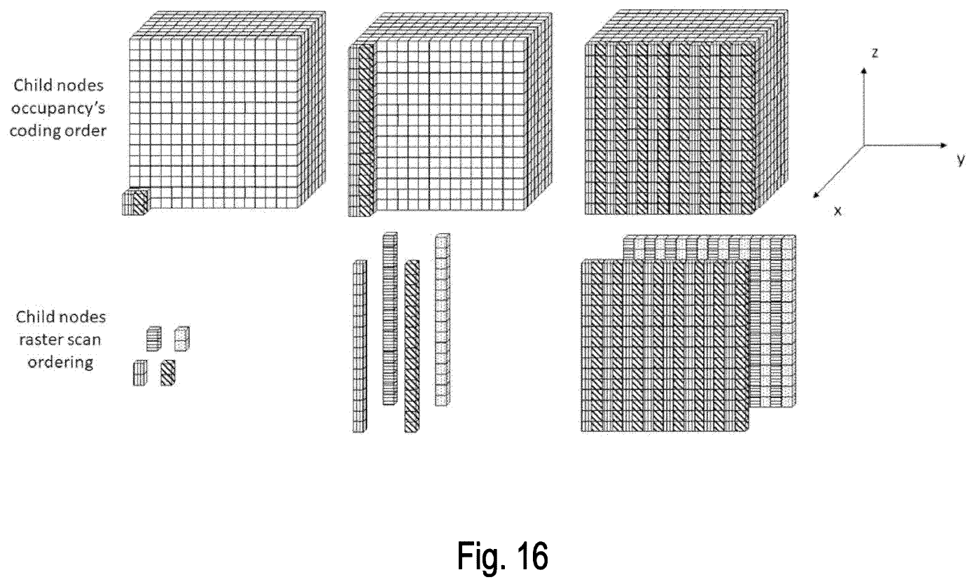

In some embodiments, the proposed method uses the raster scan order of the nodes to code/decode the occupancy bits of all their respective child volumes (together) at a given depth in the occupancy tree. In some embodiments, as illustrated in FIG. 16, occupied nodes are processed in raster scan order, but the occupancy bits for all the child volumes of the nodes are successively coded by an order in a single pass on the node, for instance using Morton scan ordering of the child nodes occupancy bits (it means code the child volumes of each node using Morton order in a single pass on the node); and to order the child nodes by raster scan order for next depth, it uses child nodes ordering method same as that in the embodiments which uses 4 passes on each node at current depth and is shown in FIG. 11.

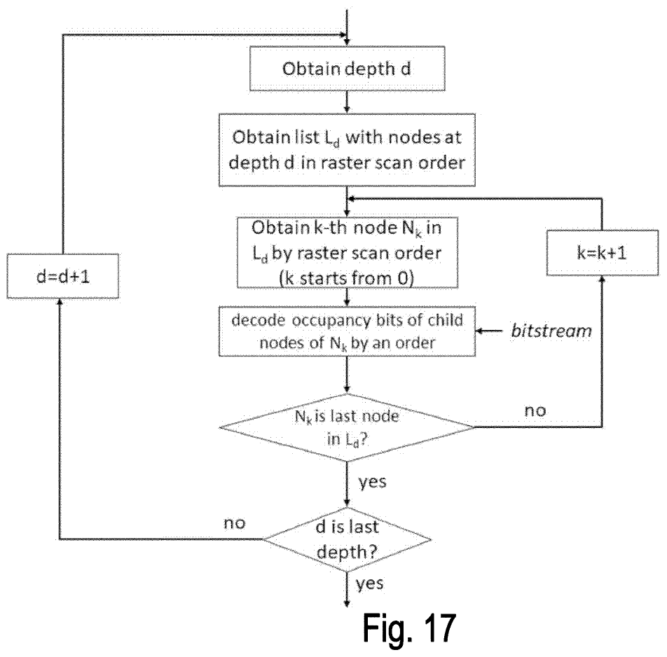

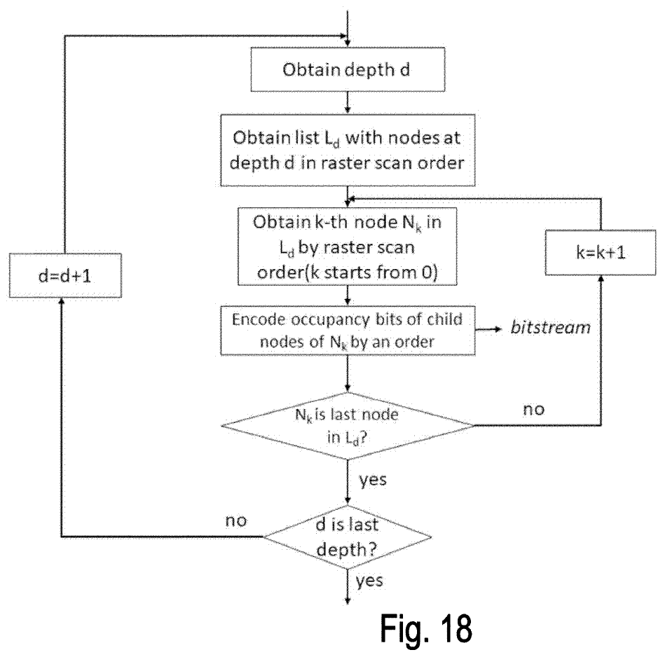

FIG. 17 shows an example of child nodes occupancy decoding process of decoder in some embodiments, and FIG. 18 shows an example of the encoder of the some embodiments, and the ordering process of child nodes is not shown in both FIG. 17 and FIG. 18.

The detailed process in encoder/decoder can be described as below:
Obtain a fifo list La storing nodes at depth d by raster scan order
Obtain node Nₖ(xₖ, yₖ, zₖ) at depth d from the fifo list L_{d}, and initially at each depth it starts from the first node N₀(x₀, y₀, z₀),
decode/encode its child nodes occupancy bits by an order, like Morton order, from/into bitstream,
if Nₖ is not last node in the fifo list L_{d}, go to encode/decode next node Nₖ₊₁(xₖ₊₁, yₖ₊₁, zₖ₊₁) in the fifo list L_{d} until it reaches the last node in L_{d},
go to encode child nodes occupancy of next depth until it reaches the final depth.

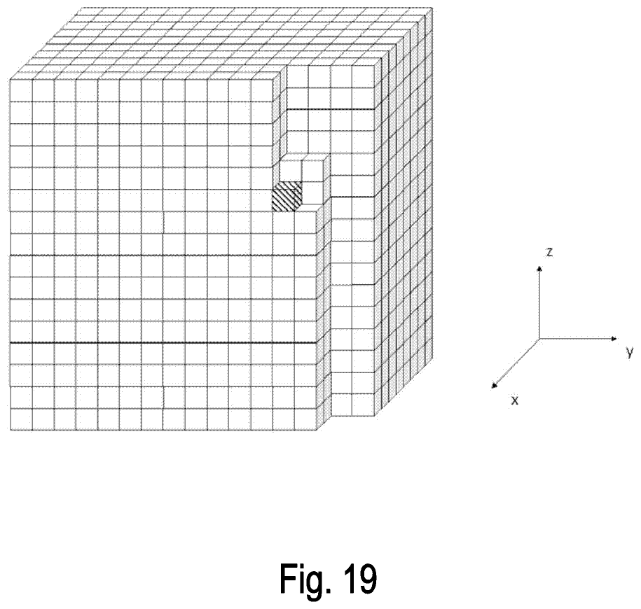

FIG. 19 shows the occupancy map of child nodes already known when coding the occupancy bit for the striped child volume when using the alternative coding order described for FIG. 16. With the raster scan ordering of the nodes (whatever is the axis ordering used in lexicographic order), the occupancy of any child volume of a node with a lower z, a lower y or a lower x position than the current node (parent node of the striped child volume) may be used for contextualizing entropy coding of the striped child volume occupancy bit, as well as any child volume occupancy bits previously coded for the current node. With this approach, it is possible to clearly distinguish there is one different pattern for the available neighbouring nodes for each position of the coded child volume occupancy. Thus, with octree occupancy there are 8 different patterns. The entropy coding of the occupancy bits thus needs to be tuned according to each pattern (i.e., for each occupancy bit index) in order to be more optimal.

It complexify a bit the encoding with respective to the embodiment shown in FIG. 11, but is still more optimal than the patterns in octree with nodes coded in Morton order as that in prior art. In the prior art, with Morton ordering of the nodes, the pattern for “unknown” (i.e., not yet coded) neighbouring nodes occupancy vary much more with the positions in the ancestor nodes (and so with the Morton index), thus some neighbouring information is not always reliable when building the entropy contexts and it may introduce bias in entropy coding probabilities built in adaptive entropy coding context, thus reducing the coding performances.

It should be understood that in point cloud coding, the occupied nodes and child nodes would rarely (and in some embodiments never) be as dense as in example in FIG. 4, FIG. 9, FIG. 13 and FIG. 16. These figures are densely represented to provide a better view of the causal child occupancy information available and of the nodes/child nodes processing order. In usual point clouds several volumes will be unoccupied, and so, no nodes for these volumes will exist and will be processed. The processing order of the occupied nodes remain the same as if the content was dense, and for a given occupied node the occupancy of all the children volumes is always coded, but the unoccupied nodes/volumes are not processed at all because they are not present in the tree structure. In comparison to the processing order of a dense content, the processing of these unoccupied nodes/volume is just skipped.

In embodiments as illustrated in FIG. 16 for example, the raster scan order of child nodes in depth d+1 is obtained by processing their parent node 4 times at depth d, which increases the complexity of runtime.

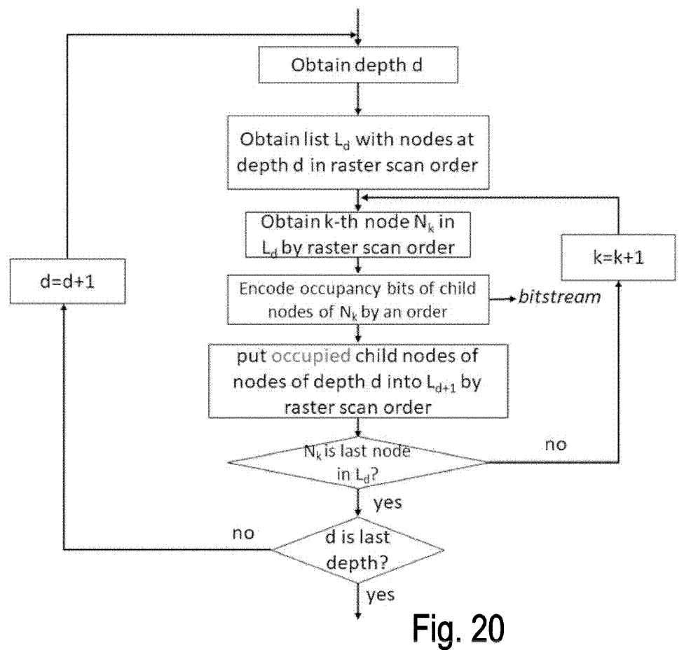

To reduce the runtime complexity, in some embodiments the method orders the child nodes by raster scan order without using 4 passes on each node. In some embodiments as shown in FIG. 20. In the step of putting occupied child nodes of Nₖ of depth d into L_{d+1} by raster scan order, it uses intermediate lists to order the child nodes in a single pass on the nodes. The occupancy tubes of child nodes 0 to 3 are maintained in 4 separate lists, which are Lₜ₀, Lₜ₁, Lₜ₂ and Lₜ₃ separately. These lists will be used to build the occupancy slices of child nodes 0 and 1 which are maintained in 2 separate lists, which are Lₛ₁ and Lₛ₁. Finally, the list L_{d+1} is built from lists Lₛ₀ and Lₛ₁.

In detail, as for Nₖ(xₖ, yₖ, zₖ) of depth d (k starts from 0), in this step:
it puts (appends at the end) new nodes for each occupied child nodes of tube 0 into list Lₜ₀,
new nodes for each occupied child nodes of tube 1 into list Lₜ₁,
new nodes for each occupied child nodes of tube 2 into list Lₜ₂,
and new nodes for each occupied child nodes of tube 3 into list Lₜ₃;
wherein occupied child nodes of each tube are processed from bottom to top.

After iterating on all child nodes of a tube of (parents) nodes of same x and same y of depth d, tube lists can be appended to slices lists: Lₜ₀ is appended at the end of Lₛ₀, then Lₜ₁ is appended at the end of Lₛ₀; and Lₜ₂ is appended at the end of Lₛ₁, then Lₜ₃ is appended at the end of Lₛ₁. This provides child nodes ordered in raster scan order in each slice lists Lₛ₀ and Lₛ₁. Then, empty tube lists are used to process next tube of (parent) nodes.

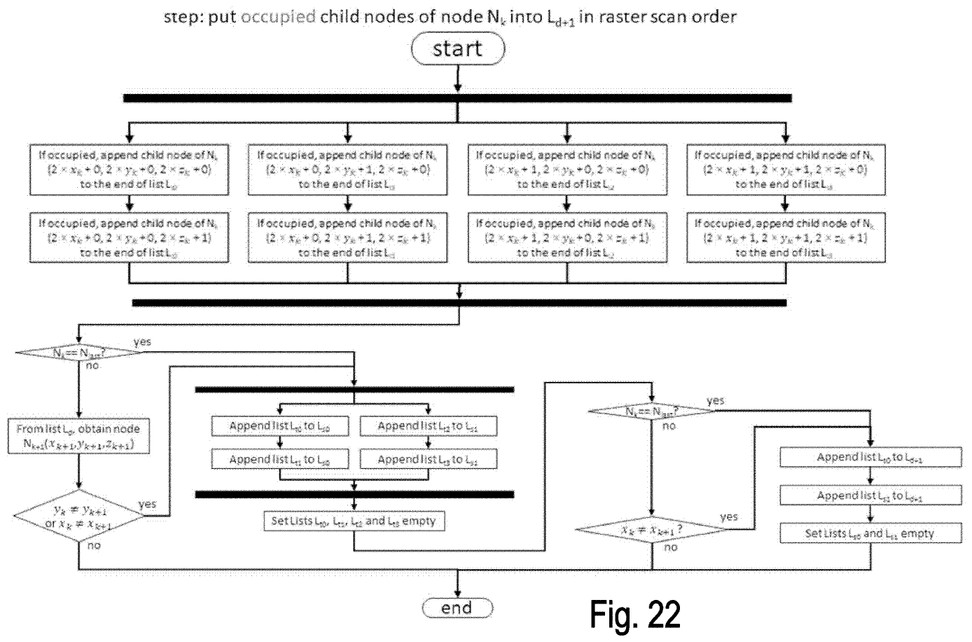

After iterating on all child nodes of a slice of (parents) nodes of same x of depth d, slice lists can be appended to next depth list L_{d+1}: L₀ is appended at the end of L_{d+1} then Lₛ₁ is appended at the end of L_{d+1}. Empty slice lists are used to process next slice of (parent) nodes. This provides child nodes ordered in raster scan order in the list for next depth L_{d+1}. The detail process to put occupied child nodes of node Nₖ into L_{d+1} in raster scan order is shown in FIG. 22.

Appending list one to the other may be costly in runtime, if lists are implemented using memory blocks: memory need to be copied, and memory allocation may be needed. To avoid this issue, in an embodiment the list Lₜ₀, Lₜ₁, Lₜ₂, Lₜ₃, Lₛ₀, Lₛ₁, L_{d} and L_{d+1} are implemented using (dynamically) linked lists. Thus appending one list to the other may have a complexity in O(1). These intermediate buffers allow to keep a single pass processing of the nodes.

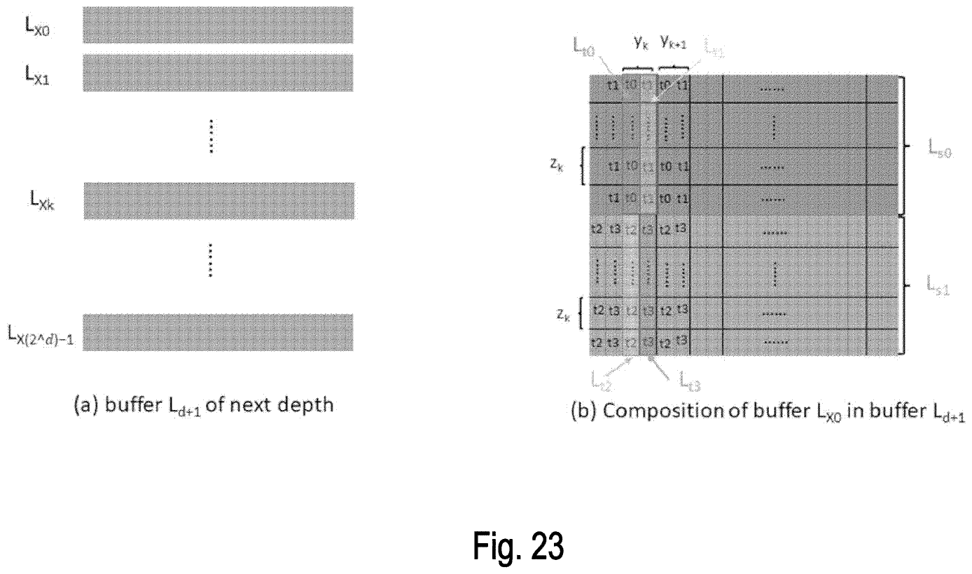

The obtained buffer L_{d+1} storing child nodes in raster scan order for next depth is shown in FIG. 23(a) and (b), FIG. 23(a) shows the buffer L_{d+1} contains buffers Lₓ (from Lₓ₀ to L_{x(2\hat{ }d)-1}) for nodes with same x and FIG. 23(a) shows the structure of buffer Lₓ₀, which consists of Lₜ₀, Lₜ₁, Lₜ₂, Lₜ₃. And the buffer L_{d+1} is organized as:
buffers Lₜ₀ and Lₜ₁: Lₜ₀ is for tube 0 of occupied nodes with same x and same y (which is labeled in FIG. 23 (b)), and Lₜ₁ is for tube 1 of occupied nodes with same x and same y which is labeled in FIG. 23 (b), and by an increasing y order they are successively appended to a buffer L₀ for slice0 of occupied nodes with same x;
and buffers Lₜ₂ and Lₜ₃: Lₜ₂ is for tube 2 of occupied nodes with same x and same y (which is labeled in FIG. 23(b)), and Lₜ₃ is for tube 3 of occupied nodes with same x and same y which is labeled in FIG. 23(b), and by an increasing y order they are successively appended to a buffer Lₛ₁ for slice1 of occupied nodes with same x;
Buffer L₀ for occupancy slice0 of occupied nodes with same x is appended to buffer Lₛ₁ for occupancy slice1 of occupied nodes with same x to form buffer Lₓ, which is represented as, for example, Lₓ₀ (for x=x1) and Lₓ₁ (for x=x0), in FIG. 23 (a);
buffers Lₓ is appended at the end of buffer Lₓ₋₁. At depth d, the raster scan ordered child nodes in buffer L_{d+1} (being built for next depth occupancy coding) are obtained by appending buffers Lₓ one after another by increasing x.

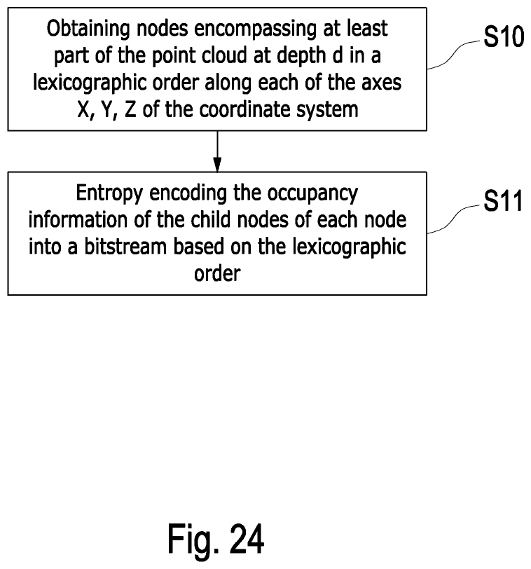

Reference is now made to FIG. 24 showing a schematic flow diagram of the method for encoding a 3D point cloud into a bitstream according to the present disclosure.

The method includes:

In step S10, nodes encompassing at least part of the point cloud at depth d in a lexicographic order along each of the axes X, Y, Z of the coordinate system is obtained;

In step S11, the occupancy information of the child nodes of each node is entropy encoded into a bitstream based on the lexicographic order.

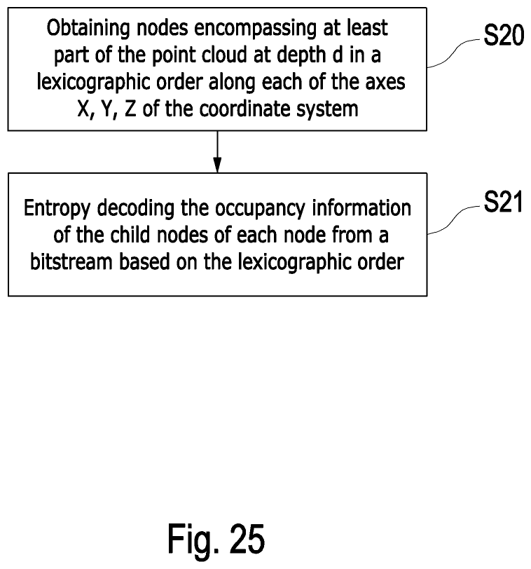

Reference is now made to FIG. 25 showing a schematic flow diagram of the method for decoding a 3D point cloud from a bitstream according to the present disclosure.

The method includes:

In step S20, nodes encompassing at least part of the point cloud at depth d in a lexicographic order along each of the axes X, Y, Z of the coordinate system are obtained;

In step S21, the occupancy information of the child nodes of each node is entropy decoded from a bitstream based on the lexicographic order.

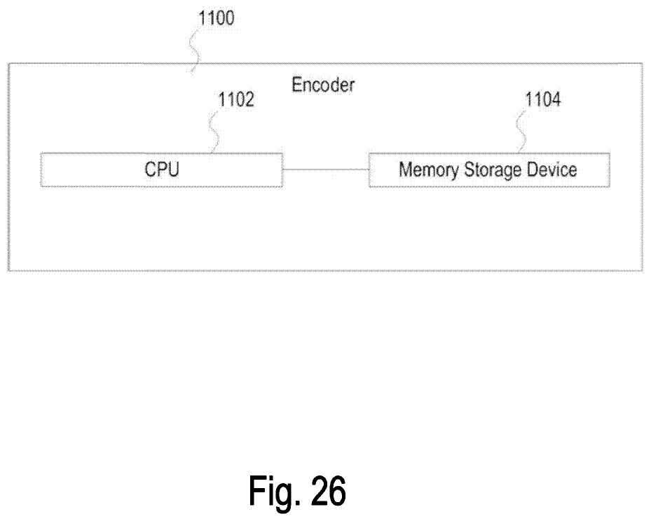

Reference is now made to FIG. 26, which shows a simplified block diagram of an example embodiment of an encoder 1100. The encoder 1100 includes a processor 1102 and a memory storage device 1104. The memory storage device 1104 may store a computer program or application containing instructions that, when executed, cause the processor 1102 to perform operations such as those described herein. For example, the instructions may encode and output bitstreams encoded in accordance with the methods described herein. It will be understood that the instructions may be stored on a non-transitory computer-readable medium, such as a compact disc, flash memory device, random access memory, hard drive, etc. When the instructions are executed, the processor 1102 carries out the operations and functions specified in the instructions so as to operate as a special-purpose processor that implements the described process(es). Such a processor may be referred to as a “processor circuit” or “processor circuitry” in some examples.

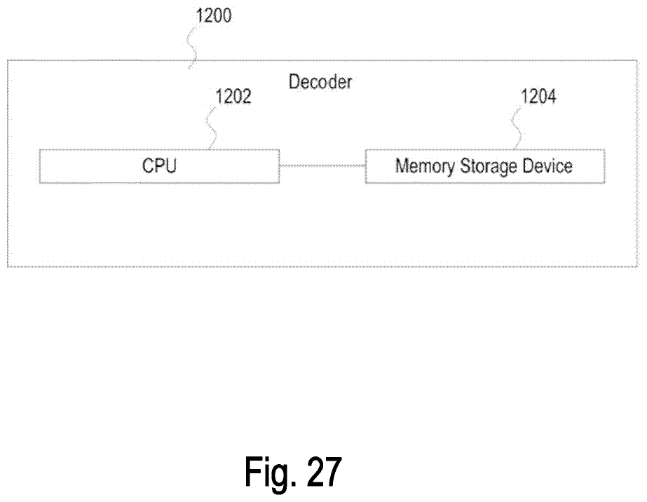

Reference is now also made to FIG. 27, which shows a simplified block diagram of an example embodiment of a decoder 1200. The decoder 1200 includes a processor 1202 and a memory storage device 1204. The memory storage device 1204 may include a computer program or application containing instructions that, when executed, cause the processor 1202 to perform operations such as those described herein. It will be understood that the instructions may be stored on a computer-readable medium, such as a compact disc, flash memory device, random access memory, hard drive, etc. When the instructions are executed, the processor 1202 carries out the operations and functions specified in the instructions so as to operate as a special-purpose processor that implements the described process(es) and methods. Such a processor may be referred to as a “processor circuit” or “processor circuitry” in some examples.

It will be appreciated that the decoder and/or encoder according to the present application may be implemented in a number of computing devices, including, without limitation, servers, suitably programmed general purpose computers, machine vision systems, and mobile devices. The decoder or encoder may be implemented by way of software containing instructions for configuring a processor or processors to carry out the functions described herein. The software instructions may be stored on any suitable non-transitory computer-readable memory, including CDs, RAM, ROM, Flash memory, etc.

It will be understood that the decoder and/or encoder described herein and the module, routine, process, thread, or other software component implementing the described method/process for configuring the encoder or decoder may be realized using standard computer programming techniques and languages. The present application is not limited to particular processors, computer languages, computer programming conventions, data structures, other such implementation details. Those skilled in the art will recognize that the described processes may be implemented as a part of computer-executable code stored in volatile or non-volatile memory, as part of an application-specific integrated chip (ASIC), etc.

The present application also provides for a computer-readable signal encoding the data produced through application of an encoding process in accordance with the present application.

Certain adaptations and modifications of the described embodiments can be made. Therefore, the above discussed embodiments are considered to be illustrative and not restrictive. In particular, embodiments can be freely combined with each other.

1. A method for decoding a 3D point cloud from a bitstream, implemented in a decoder, a geometry of the point cloud being defined in an octree-based structure having a plurality of nodes having parent-child relationships and representing a three-dimensional location of an object, the point cloud being located within a volumetric space of a three-dimensional coordinate system recursively split into sub-volumes and containing points of the point cloud, wherein a volume is partitioned into a set of sub-volumes, each associated with a node of the octree-based structure and wherein occupancy information associated with each respective child sub-volume indicates whether that respective child sub-volume contains at least one of the points, the method comprising:
obtaining nodes encompassing at least part of the point cloud at a depth d in a lexicographic order along each of axes X, Y, Z of the coordinate system; and
entropy decoding the occupancy information of the child nodes of each node from the bitstream based on the lexicographic order.

2. A method for encoding a 3D point cloud into a bitstream, implemented in an encoder, a geometry of the point cloud being defined in an octree-based structure having a plurality of nodes having parent-child relationships and representing a three-dimensional location of an object, the point cloud being located within a volumetric space of a three-dimensional coordinate system recursively split into sub-volumes and containing points of the point cloud, wherein a volume is partitioned into a set of sub-volumes, each associated with a node of the octree-based structure and wherein occupancy information associated with each respective child sub-volume indicates whether that respective child sub-volume contains at least one of the points, the method comprising:
obtaining nodes encompassing at least part of the point cloud at a depth d in a lexicographic order along each of the axes X, Y, Z of the coordinate system; and
entropy encoding the occupancy information of the child nodes of each node into the bitstream based on the lexicographic order.

3. The method according to claim 2, further comprising:
storing occupied child nodes at a depth d+1 in a lexicographic order.

4. The method according to claim 2, wherein at least one of the lexicographic order of nodes at the depth d or the lexicographic order of child nodes at a depth d+1 is a raster scan order.

5. The method according to claim 3, wherein the entropy encoding of the occupancy information of the child nodes of each node into the bitstream is based on the lexicographic order of child nodes at the depth d+1.

6. The method according to claim 2, wherein the entropy encoding of the occupancy information of the child nodes of each node into the bitstream is further based on the same neighbouring child node occupancy pattern indicating contexts for each child node.

7. The method according to claim 6, wherein the context of each child node is selected based on at least one of child nodes' occupancy pattern or and/or neighbouring parent nodes' occupancy pattern, and if neighbouring parent nodes' occupancy pattern is used for the selection of entropy coding contexts, the context selection depends on a child occupancy index within a parent node, wherein the child occupancy index indicates a position of a child node in the parent node.

8. The method according to claim 3, wherein storing the occupied child nodes at the depth d+1 in the lexicographic order is performed by processing each node in 4 passes.

9. The method according to claim 2, wherein the entropy encoding of the occupancy information of the child nodes of each node into the bitstream is based on the lexicographic order of nodes at the depth d and a fixed order of the child nodes for a given node.

10. The method according to claim 3, wherein storing the occupied child nodes at the depth d+1 is performed by processing each node in a single pass on all the nodes of obtained nodes, by using intermediate storage to order child nodes in the lexicographic order, in raster scan order.

11. The method according to claim 2, wherein the entropy encoding of each child node applies a dynamic Optimal Binary Coder with Update on the Fly (OBUF).

12. An encoder to encode a 3D point cloud into a bitstream, comprising:
at least one processor; and
a memory storing instructions executable by the processor,
wherein the processor is configured to perform the method according to claim 2.

13. A decoder to decode a 3D point cloud from a bitstream, a geometry of the point cloud being defined in an octree-based structure having a plurality of nodes having parent-child relationships and representing a three-dimensional location of an object, the point cloud being located within a volumetric space of a three-dimensional coordinate system recursively split into sub-volumes and containing points of the point cloud, wherein a volume is partitioned into a set of sub-volumes, each associated with a node of the octree-based structure and wherein occupancy information associated with each respective child sub-volume indicates whether that respective child sub-volume contains at least one of the points, the decoder comprising:
at least one processor; and
a memory storing instructions executable by the processor,
wherein the processor is configured to:
obtain nodes encompassing at least part of the point cloud at a depth d in a lexicographic order along each of axes X, Y, Z of the coordinate system; and
entropy decode the occupancy information of the child nodes of each node from the bitstream based on the lexicographic order.

14. (canceled)

15. (canceled)

16. The method according to claim 1, further comprising:
storing occupied child nodes at a depth d+1 in a lexicographic order.

17. The method according to claim 1, wherein at least one of the lexicographic order of nodes at the depth d or the lexicographic order of child nodes at a depth d+1 is a raster scan order.

18. The method according to claim 16, wherein the entropy decoding of the occupancy information of the child nodes of each node from the bitstream is based on the lexicographic order of child nodes at the depth d+1.

19. The method according to claim 1, wherein the entropy decoding of the occupancy information of the child nodes of each node from the bitstream is further based on the same neighbouring child node occupancy pattern indicating contexts for each child node.

20. The method according to claim 19, wherein the context of each child node is selected based on at least one of child nodes' occupancy pattern or neighbouring parent nodes' occupancy pattern, and if neighbouring parent nodes' occupancy pattern is used for the selection of entropy coding contexts, the context selection depends on a child occupancy index within a parent node, wherein the child occupancy index indicates a position of a child node in the parent node.

21. The method according to claim 16, wherein storing the occupied child nodes at the depth d+1 in the lexicographic order is performed by processing each node in 4 passes.

22. The method according to claim 1, wherein the entropy decoding of the occupancy information of the child nodes of each node from the bitstream is based on the lexicographic order of nodes at the depth d and a fixed order of the child nodes for a given node.
